(19) United States
(12) Patent Application Publication
(10) Pub. No.: US 2016/0034909 A1
(43) Pub. Date: Feb. 4, 2016

(54) INCORPORATING GREEN SCORES INTO AN E-COMMERCE SYSTEM

(71) Applicants: Geng Zhu, Shanghai (CN); Zhen Ge, Shanghai (CN); Vincent Muliahy-Flores, San Jose, CA (US); Lin Chen, Shanghai (CN)

(72) Inventors: Geng Zhu, Shanghai (CN); Zhen Ge, Shanghai (CN); Vincent Muliahy-Flores, San Jose, CA (US); Lin Chen, Shanghai (CN)

(21) Appl. No.: 14/586,475

(22) Filed: Dec. 30, 2014

Related U.S. Application Data
(60) Provisional application No. 62/032,497, filed on Aug. 1, 2014.

(51) Int. Cl. G06Q 30/00; G06Q 30/06

(52) U.S. Cl. CPC G06Q 30/018; G06Q 30/0609; G06Q 30/0621

(57) ABSTRACT

A method of encouraging environmental-friendliness among users of a network-based publication system is disclosed. It is detected that a user of a network-based publication system has engaged in a transaction. A transaction green score is calculated for the transaction. The transaction green score reflects an impact on the environment of the engagement by the user in the transaction. A user green score for the user is calculated. The calculating of the user green score includes combining the transaction green score with previous transaction green scores calculated for previous engagements by the user in previous transaction. The user green score is communicated for presentation in a user interface.

### CROSS-REFERENCE TO RELATED APPLICATIONS

This application claims the benefit of priority to U.S. Provisional Patent Application Ser. No. 62/032,497, filed Aug. 1, 2014, which is incorporated herein by reference in its entirety.

### TECHNICAL FIELD

The present application relates generally to the technical field of electronic commerce systems, and, in one specific example, to incorporating green scores into a network-based publication system to encourage users of the system to choose actions with respect to the system that will result in a more positive (or a less negative) impact on the environment than other actions.

### BACKGROUND

Various electronic commerce (e-commerce) systems or network-based publication systems such as eBay, Amazon, or craigslist facilitate exchanges of items (e.g., goods or services) between users. Users of such systems may lack knowledge of how choices they make with respect to the exchanges may impact the environment in which they live.

### BRIEF DESCRIPTION OF THE DRAWINGS

Some embodiments are illustrated by way of example and not limitation in the figures of the accompanying drawings.

FIG. 1 is a network diagram depicting a client-server system within which various example embodiments may be deployed.

FIG. 2 is a block diagram illustrating multiple applications including best offer applications that, in various example embodiments, are provided as part of the networked system of FIG. 1.

FIG. 3A is a block diagram illustrating example modules of the client application(s) of FIG. 1.

FIG. 3B is a block diagram illustrating example modules of the green-scoring application(s) of FIG. 2.

FIG. 4 is a flowchart illustrating example operations of a method of calculating and communicating a user green score for presentation in a user interface.

FIG. 5 is a flowchart illustrating example operations of a method of calculating and communicating a user green score for presentation in a user interface.

FIG. 6 is a flowchart illustrating example operations of a method of calculating and communicating item green score for presentation to a user in conjunction with search results.

FIG. 7 is a flowchart illustrating example operations of a method of rewarding users based on their green scores.

FIG. 8 is a flowchart illustrating example operations of a method of selecting advertising for presentation to a user based on a green score of the user. In various embodiments, the method 800 may be performed by various modules of the green-scoring application(s) 234.

FIG. 9 is an example embodiment of a user interface of a profile of a user in which a green score associated with the user is depicted. In this example, a user profile is shown.

FIG. 10 is an example embodiment of a user interface depicting a green score leaderboard and targeted green score advertising.

FIG. 11 is an example embodiment of a user interface depicting an option to filter or rank search results corresponding to items listed on the network-based publication system based on their green scores.

FIG. 12 is an example embodiment of a user interface depicting results of a green filter being applied to search results as well as a visual representation of an item green score

FIG. 13 is a block diagram of machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

A method of encouraging environmental-friendliness among users of a network-based publication system is disclosed. It is detected that a user of a network-based publication system has engaged in a transaction. A transaction green score is calculated for the transaction. The transaction green score reflects an impact on the environment of the engagement by the user in the transaction. A user green score for the user is calculated. The calculating of the user green score includes combining the transaction green score with previous transaction green scores calculated for previous engagements by the user in previous transaction. The user green score is communicated for presentation in a user interface.

This method and various embodiments disclosed herein may be implemented as a computer system having one or more modules (e.g., hardware modules or software modules). This method and various embodiments disclosed herein may be embodied as instructions stored on a machine-readable medium that, when executed by a processor, cause the processor to perform the method.

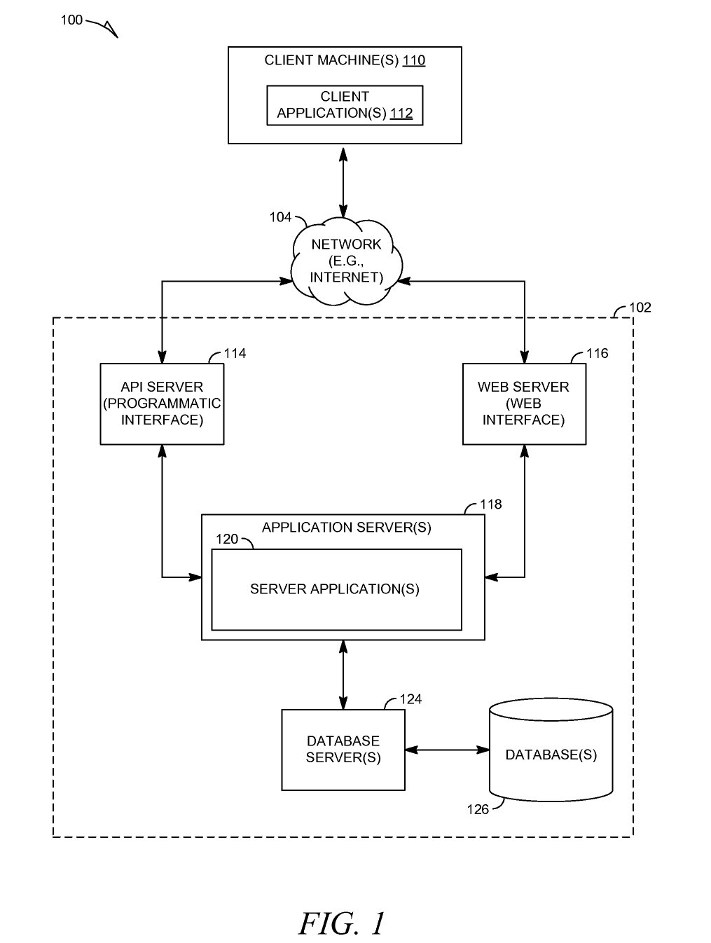

FIG. 1 is a network diagram depicting a system 100 within which various example embodiments may be deployed. A networked system 102, in the example forms of a network-based marketplace or other publication system, provides server-side functionality, via a network 104 (e.g., the Internet or Wide Area Network (WAN)) to one or more clients machines 110. FIG. 1 illustrates client application(s) 112 on the client machines 110. Examples of client application(s) 112 may include a web browser application, such as the Internet Explorer browser developed by Microsoft Corporation of Redmond, Wash. or other application supported by an operating system of the device, such as Windows, iOS or Android operating systems. Each of the client application(s) 112 may include a software application module (e.g., a plug-in, add-in, or macro) that adds a specific service or feature to a larger system.

An API server 114 and a web server 116 are coupled to, and provide programmatic and web interfaces respectively to, one or more application servers 118. The application servers 118 host one or more server application(s) 120. The application servers 118 are, in turn, shown to be coupled to one or more database servers 124 that facilitate access to one or more databases 126 or data stores, such as NoSQL or non-relational data stores.

The applications 120 may provide a number of marketplace functions and services to users that access the networked system 102. While the applications 120 are shown in FIG. 1 to form part of the networked system 102, in alternative embodiments, the various applications 120 may form part of a service that is separate and distinct from the networked system 102.

Further, while the system 100 shown in FIG. 1 employs a client-server architecture, various embodiments are, of course, not limited to such an architecture, and could equally well find application in a distributed, or peer-to-peer, architecture system, for example. The various server applications 120 could also be implemented as standalone software programs, which do not necessarily have networking capabilities. Additionally, although FIG. 1 depicts machines 110 as being coupled to a single networked system 102, it will be readily apparent to one skilled in the art that client machines 110, as well as client applications 112, may be coupled to multiple networked systems, such as payment applications associated with multiple payment processors or acquiring banks (e.g., PayPal, Visa, MasterCard, and American Express).

Web applications executing on the client machine(s) 110 may access the various applications 120 via the web interface supported by the web server 116. Similarly, native applications executing on the client machine(s) 110 may accesses the various services and functions provided by the applications 120 via the programmatic interface provided by the API server 114. An example of one of the client application(s) 112 may be a seller application (e.g., the TurboLister application developed by eBay Inc., of San Jose, Calif.) that enables sellers to author and manage listings on the networked system 102 in an off-line manner, and to perform batch-mode communications between the client application(s) 112 and the networked system 102. Other examples of client application(s) 112 may be third-party applications. For example, the third-party applications may, utilizing information retrieved from the networked system 102, support one or more features or functions on a website hosted by the third party. The third-party website may, for example, provide one or more promotional, marketplace or payment functions that are supported by the relevant applications of the networked system 102.

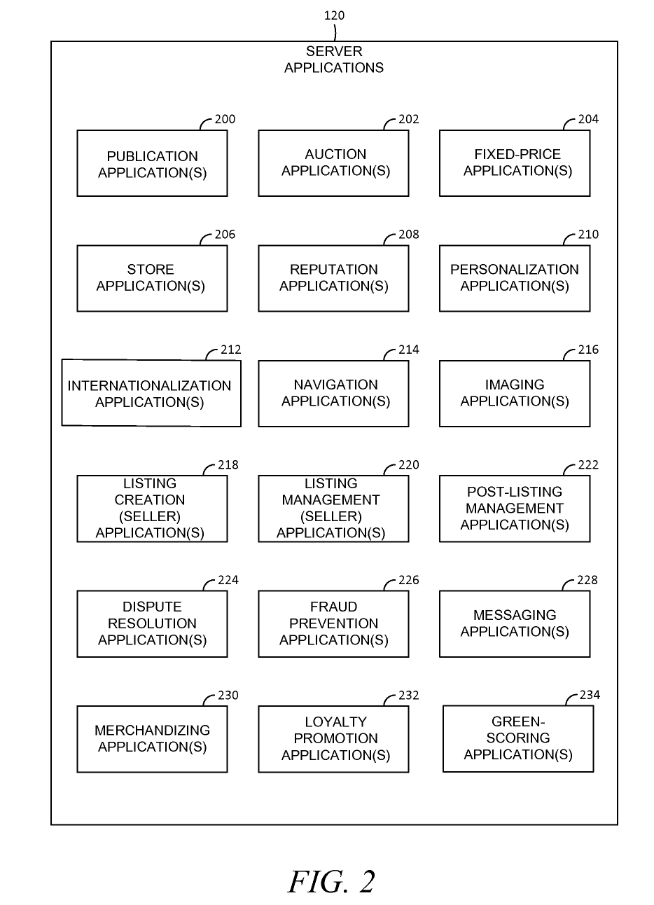

FIG. 2 is a block diagram illustrating multiple server applications 120 that, in various example embodiments, are provided as part of the networked system 102. The server applications 120 may be hosted on dedicated or shared server machines (not shown) that are communicatively coupled to enable communications between server machines. The server applications 120 themselves are communicatively coupled (e.g., via appropriate interfaces) to each other and to various data sources, so as to allow information to be passed between the server applications 120 so as to allow the server applications 120 to share and access common data. The server applications 120 may furthermore access one or more databases 126 via the database servers 124.

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the server applications 120 are shown to include at least one publication application 200 and one or more auction applications 202 which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives and features that are specific and personalized to a relevant seller.

Reputation applications 208 allow users that transact, utilizing the networked system 102, to establish, build and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (e.g., through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. For instance, a version of the networked system 102 may be customized for the United Kingdom, whereas another version of the networked system 102 may be customized for the United States. Each of these versions may operate as an independent marketplace, or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application) may enable keyword searches of listings published via the networked system 102. A browse application may allow users to browse various category, catalogue, or inventory data structures according to which listings may be classified within the networked system 102. Various other navigation applications may be provided to supplement the search and browsing applications.

In order to make listings available via the networked system 102 as visually informing and attractive as possible, the marketplace applications 120 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular or predetermined seller has authored and/or published a large number of listings, the management of such listings may present a challenge. The listing management applications 220 provide a number of features (e.g., auto-relisting, inventory level monitors, etc.) to assist the seller in managing such listings. The listing creation application 218 and listing management applications 220 may allow sellers to manage listing in bulk (e.g., in a single operation, such as by an uploading of a file) and provide templates for sellers to manage category-specific, vendor-specific, or general-type-specific (e.g., catalog or ticket) listings. One or more post-listing management applications 222 also assist sellers with a number of activities that typically occur post-listing. For example, upon completion of an auction facilitated by one or more auction applications 202, a seller may wish to leave feedback regarding a particular or predetermined buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of operations in an attempt to settle a dispute. In the event that the dispute cannot be settled via the guided procedures, the dispute may be escalated to a third-party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102. These messages may, for example, advise users regarding the status of listings at the networked system 102 (e.g., providing “outbid” notices to bidders during an auction process or providing promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotion applications 232. For example, a buyer may earn loyalty or promotions points for each transaction established and/or concluded with a particular or predetermined seller, and may be offered a reward for which accumulated loyalty points can be redeemed.

Green-scoring application(s) 234, described in more detail below, may be used to encourage users of the network-based publication system to make environmentally-friendly decisions when engaging in transactions on the network-based publication system.

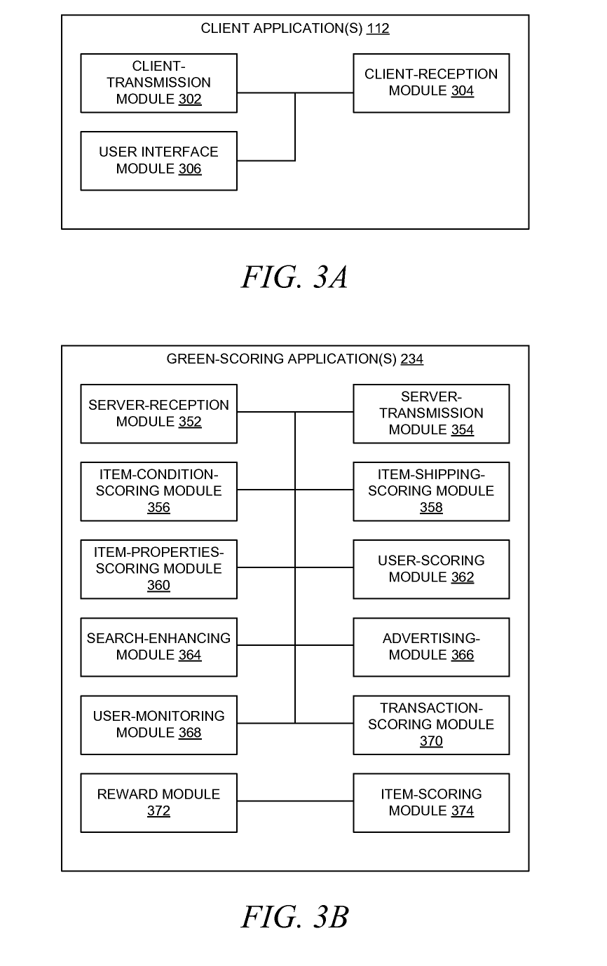

FIG. 3A is a block diagram illustrating example modules of the client application(s) 112. A client transmission module 302 may be configured transmit communications from client application(s) 112 (e.g., to the green-scoring application(s) 234). A client-reception module 304 may be configured to receive communications (e.g., from the green-scoring application(s) 234). A user interface module 306 may be configured to present one or more user interfaces, such as user interfaces depicting green scores associated with users of the network-based publications system or green scores associated with items users may select, such as conditions of the items, shipping options available for the items, and properties of the items, as will be described in more detail below.

FIG. 3B is a block diagram illustrating example modules of the green-scoring application(s) 234. A server-reception module 352 may be configured to receive communications (e.g., from the client application(s) 112). A server-transmission module 360 may be configured to send communications (e.g., to the client application(s) 112). An item-condition-scoring module 356 may be configured to determine or generate an item condition green score for items that are listed on a network-based publication. For example, the item-condition scoring module 356 may generate a higher item condition green score for an item that is in used condition than an item that is in refurbished condition and a higher item condition green score for an item that is in refurbished condition than an item that is in new condition. Thus, for example, on a scale of 1 to 10, an item in new condition may be assigned an item condition green score of 0, an item in refurbished condition may be assigned an item condition green score of 5, and an item in used condition may be assigned an item condition green score of 10.

An item-shipping-scoring module 358 may be configured to determine or generate an item shipping green score for an item. In various embodiments, the distance that the item is to be shipped may be considered in the shipping score calculation. Thus, an item that is shipped from the San Francisco in the U.S.A., to Shanghai, China would receive a lower item shipping green score than an item that is shipped over a shorter distance (e.g., locally to the buyer). In various embodiments, the shipping method chosen (e.g., airplane, vehicle, or train) may also be reflected in the calculation of the item shipping green score. In various embodiments, the carbon emissions associated with the shipping of the item may be used as a basis for determining the item shipping green score. Thus, in various embodiments, the amount of carbon emissions associated with a particular shipping method or shipping distance may be included in the calculation.

An item-properties-scoring module 360 may be configured to determine or generate an item properties green score for the item. The item properties green score may take into account various aspects of the item based on its environmental-friendliness, including environmental-friendliness of its production, packaging, operation, and disposal. In various embodiments, carbon emissions associated with the production, use, or disposal of the product may be considered in the item properties green score calculation. In various embodiments, the item properties green score for an item that is to be shipped in recyclable packaging may be higher than an item properties green score for an item that is to be shipped in non-recyclable packaging. In various embodiments, items certified to be organic may receive a higher item properties green score than an item that is non-organic. In various embodiments, information related to the environmental-friendliness of a product (e.g., carbon emissions associated with a product, packaging associated with a product, the organic nature of a product, etc.) may be retrieved from an external system and analyzed to generate the item properties green score for the item. In various embodiments, information entered by a seller of the item (or sellers of similar items) may be used to determine the item properties green score for the item. Thus, when listing and item on the network based publication system (e.g., as for sale), the seller of the system may prompt the user to enter information pertaining to the environmental-friendliness of the item, such as the carbon emissions associated with the item, the packaging associated with the item, the organic nature of the item, and so on.

A user-scoring module 362 may be configured to determine or generate a green score for a user. In various embodiments, the green score of the user may reflect an overall environmental-friendliness of a user based on the environmental-friendliness of transactions the user has engaged in with respect to the network-based publication system.

A search-enhancing module 364 may be configured to enhance search results pertaining to items listed on the network-based publication system with information pertaining to the environmental-friendliness of items corresponding to the search results. For example, the search-enhancing module 364 may rank items based on any combination or aggregation of green scores, including item condition green scores, item shipping green scores, and item property green scores. Additionally, the search-enhancing module 364 may consider the green user score of the user to determine a significance of the green scores of the items for search-ranking purposes. For example, the amount by which a green score boosts the ranking of an item in the search results may be larger for a user having a higher green score.

An advertising module 366 may be configured to target advertising based on user green scores associated with the users and an analysis of the content of the advertisement (e.g., an advertising green score). Thus, for example, advertisements featuring items having higher item green scores may be selected for presentation to users having higher user green scores.

A user-monitoring module 368 may be configured to monitor activities of users with respect to the network-based publication system. For example, the user-monitoring module 368 may detect that a user has submitted a search query, engaging in a transaction pertaining to an item, considering which item of a plurality of items to select from search results, considering which shipping option to select for an item, or considering whether to purchase an instance of an item based on its condition. In response to detection of various activities of the user, the green-scoring application(s) 234 may present the user with information pertaining to the environmental-friendliness of each of the user's options pertaining to a transaction for an item.

A transaction-scoring module may be configured to calculate green scores associated with transactions engaged in by users of the network-based publication system. For example, various green scores (e.g., item shipping, item condition, and item properties) may be scaled (e.g., from 0 to 10), weighted, and combined to arrive at an transaction green score associated with one or more of the transactions engaged in by the user.

A reward module 372 may be configured to calculate rewards to provide to users with the highest green scores, as will be described in more detail below.

An item-scoring module 374 may be configured to determine item green scores, including item condition and item properties green scores, as will be described in more detail below.

In various embodiments, various functions of the client application(s) 112 may be provided by the green-scoring application(s) 234 of the server application(s) 120 instead of, in addition to, or in combination with the client application(s) 112. For example, green score calculation functions may be distributed between the client and server applications.

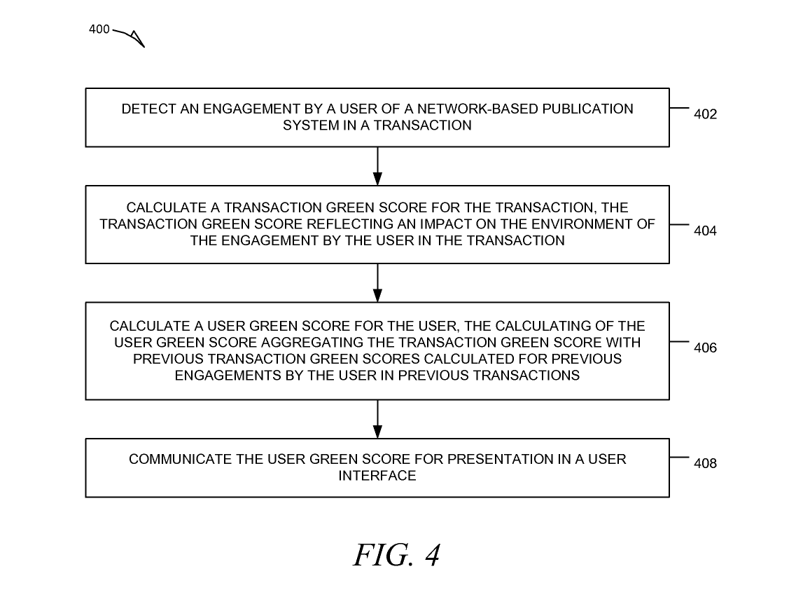

FIG. 4 is a flowchart illustrating example operations of a method 400 of calculating and communicating a user green score for presentation in a user interface. In various embodiments, the method 400 may be performed by various modules of the green-scoring application(s) 234.

At operation 402, the user-monitoring module 368 may detect that a user has engaged in a transaction. For example, the user-monitoring module 368 may detect that the user has agreed to purchase an instance of an item from a seller of the item.

At operation 404, a transaction score for the transaction is calculated. Here, the transaction green score reflects the impact on the environment of the engagement by the user in the transaction. The transaction green score may represent a combination or aggregation of one or more item green scores, including an item condition green score, an item shipping green score, or an item properties green score associated with the transaction, as described above with respect to FIG. 3B. The various item green scores may be weighted according to an assessment of their contribution to the overall impact on the environment of a transaction involving the item. The various item green scores may then be combined (e.g., as a sum, weighted sum, average, and so on) to determine the transaction green score. In various embodiments, the item-condition-scoring module 356 may detect the item condition green score for the transaction. For example, the item-condition-scoring module may determine the item condition green score for the transaction based on, for example, whether the item is in new, refurbished, or used condition. The item-shipping-scoring module 358 may determine the item shipping green score for the transaction based on, for example, a distance of shipping or a method of shipping associated with the transaction. The item-properties scoring module 360 may determine the item properties green score for the transaction based on properties of the item, such as whether the item is organic or packaged using recyclable materials.

At operation 406, the user-scoring module 364 may calculate a user green score for the user. In various embodiments, the user green score reflects an overall green score associated with transactions that the user has engaged in with respect to the network-based publication system. In various embodiments, for example, the user green score may be a combination of transaction green scores associated with transactions the user has engaged in with respect to the network-based publication system (e.g., a sum, weighted sum, average, and so on). In various embodiments, more recent transactions of the user may be weighted more heavily than older transactions of the user. In various embodiments, only a percentage or a predetermined number of the most recent transactions of the user may be considered in the calculation of the user green score.

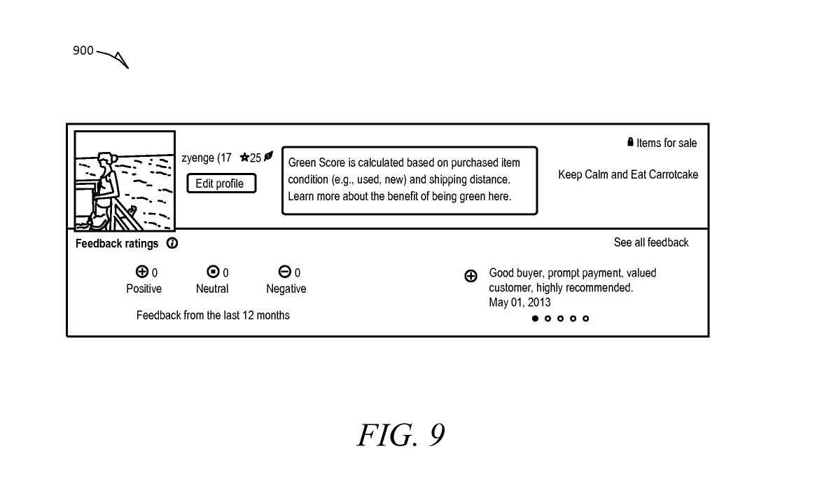

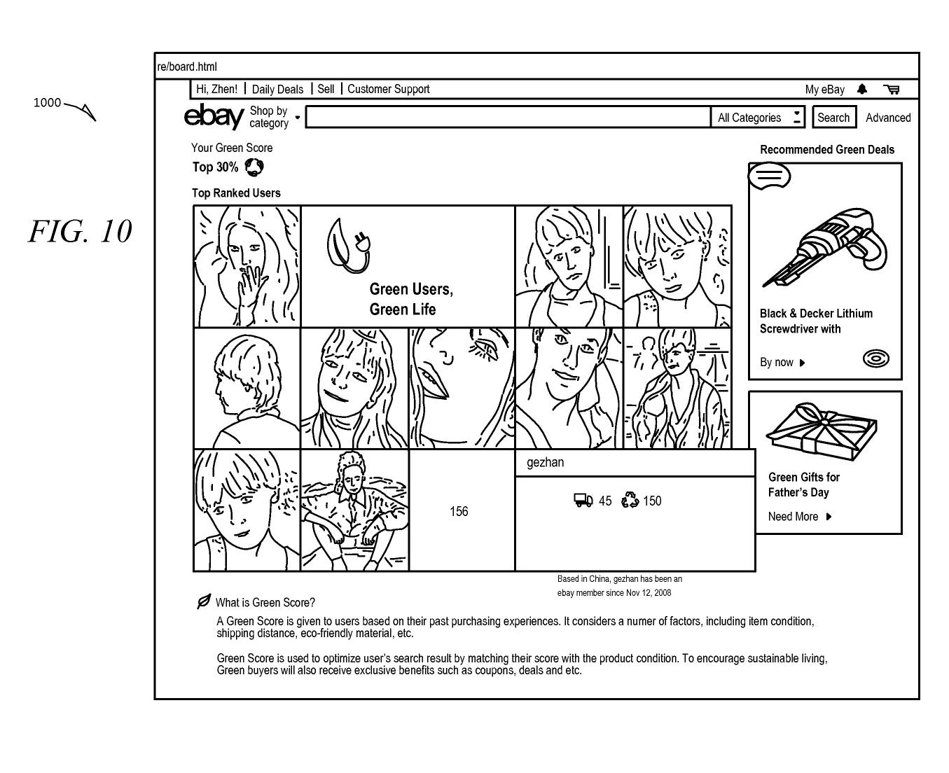

At operation 408, the server-transmission module 354 may communicate the user green score for presentation in a user interface. For example, the user green score may be presented as an element of a profile corresponding to the user (see, e.g., FIG. 9). Or the user green score may be presented in a user interface for a green-score user leaderboard served by the network-based publication system (see, e.g., FIG. 10).

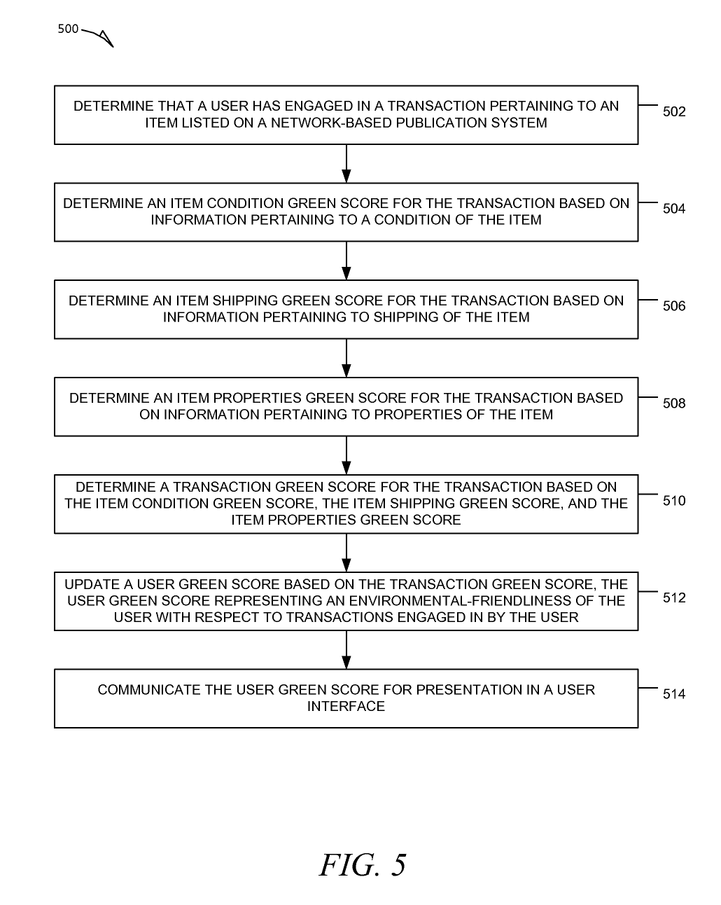

FIG. 5 is a flowchart illustrating example operations of a method 500 of calculating and communicating a user green score for presentation in a user interface. In various embodiments, the method 500 may be performed by various modules of the green-scoring application(s) 234.

At operation 502, the user-monitoring module 368 determines that a user has engaged in a transaction pertaining to an item listed on a network-based publication system.

At operation 504, the item-condition-scoring module 356 determines an item condition green score for the transaction based on information pertaining to a condition of the item, as described above.

At operation 506, the item-shipping-scoring module 358 determines an item shipping green score for the transaction based on information pertaining to the shipping of the item, as described above.

At operation 508, the item-properties-scoring module 360 determines an item properties green score for the transaction based on information pertaining to properties of the item, as described above.

At operation 510, the transaction-scoring module 362 determines a transaction green score for the item is calculated based on at least one of or a combination of the item condition green score, the item shipping green score, and the item properties green score, as described above.

At operation 512, a user green score for the user is calculated or updated based on the transaction green score, as described above.

At operation 514, the user green score is communicated for presentation in a user interface.

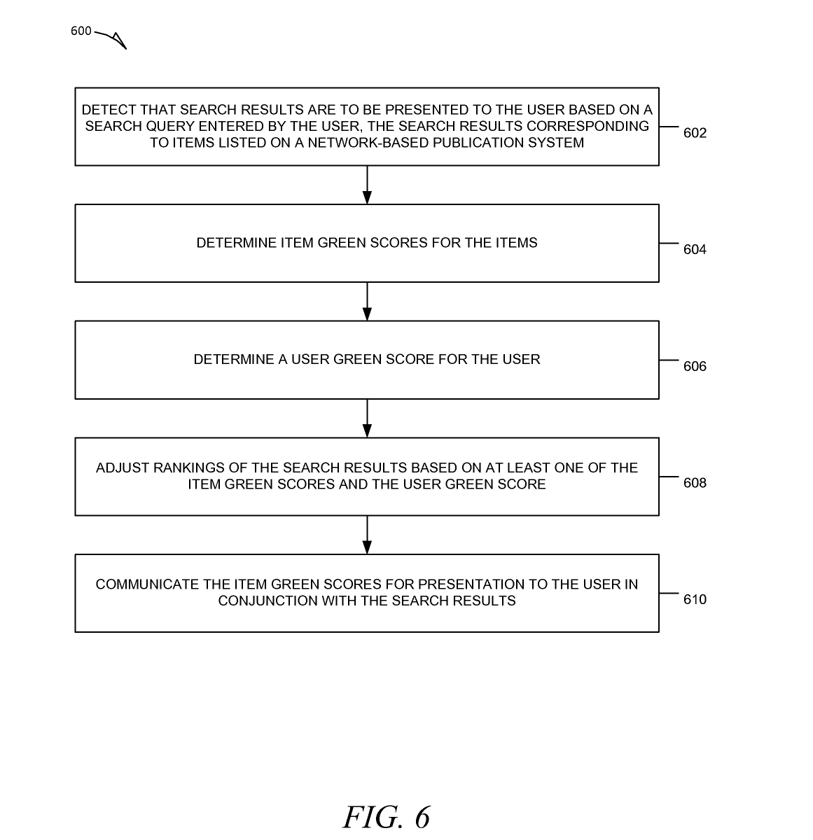

FIG. 6 is a flowchart illustrating example operations of a method 600 of calculating and communicating item green score for presentation to a user in conjunction with search results. In various embodiments, the method 600 may be performed by various modules of the green-scoring application(s) 234.

At operation 602, the user-monitoring module 368 detects that search results are to be presented to the user based on a search query entered by the user. Here the search results correspond to items listed on a network-based publication system.

At operation 604, the item-scoring module 364 calculates item green scores for the items. For example, item properties green scores are calculated for the items and item shipping options are calculated for the items. The item green scores may represent one or a combination of the item properties green scores and item shipping green scores.

At operation 606, the user-scoring module determines the user green score for the user.

At operation 608, the search-enhancing module 364 adjusts the rankings of the search results based on at least one of the item green scores and the user green score. For example, items having higher green scores are boosted in the rankings Additionally, the amount of the boost may be based on the user green score. Thus, users who are more environmentally-friendly may receive search item results in more environmentally-friendly items are emphasized more heavily than for users who are not as environmentally-friendly. In various embodiments, the searcher may specify whether items in the search results receive a boost based on their green scores.

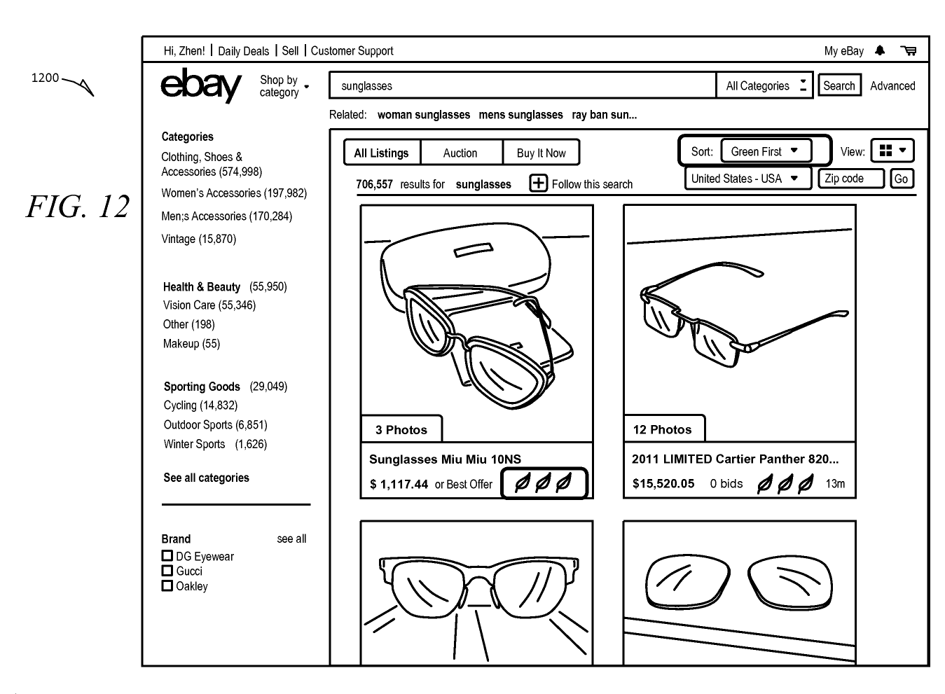

At operation 610, the server-transmission module 350 communicates the item green scores for presentation to the user in conjunction with the search results. For example, the item green scores may be presented in the search results alongside other information pertaining to the items featured in the searched results, such as the names of the items (e.g., see FIG. 12).

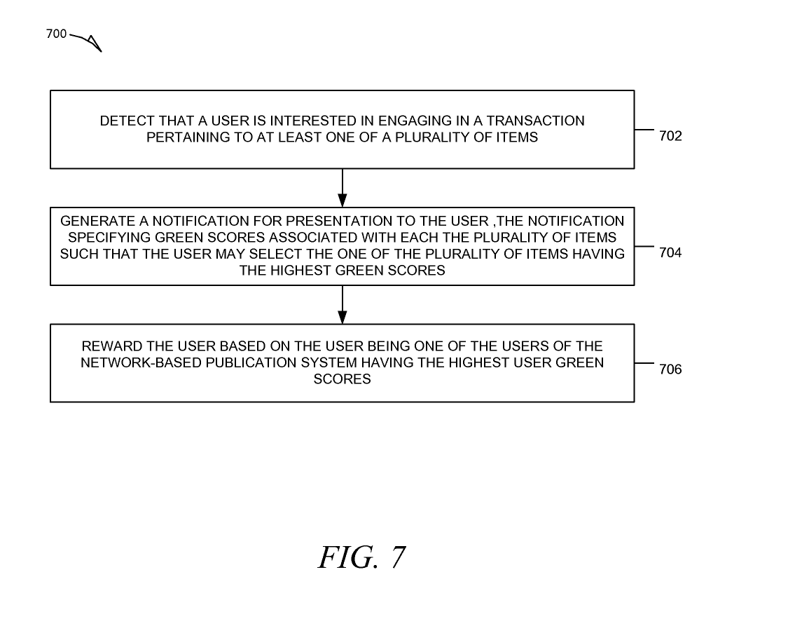

FIG. 7 is a flowchart illustrating example operations of a method 700 of rewarding users based on their green scores. In various embodiments, the method 700 may be performed by various modules of the green-scoring application(s) 234.

At operation 702, the user-monitoring module 368 detects that a user is interested in engaging in a transaction pertaining to at least one of a plurality of items. For example, the user-monitoring module detects that the user is choosing from among a set of listings of items on which to submit a bid or complete a transaction.

At operation 704, the search-enhancing module generates a notification for presentation to the user. The notification specifies green scores associated with each of items, such as the item properties green score or the item shipping green scores associated with candidate shipping options for the item. Thus, upon being presented with the green scores, the user may be provided with information relevant to selecting an item based on its environmental-friendliness.

At operation 706, the reward module 372 rewards the user based on the user being one of the users of the network-based publication system having the highest user green scores. For example, the user may be ranked on a leaderboard of top users having the highest green scores (e.g., see FIG. 10). Or the user may be provided with special offers available only to users having a green score that surpasses a threshold user green score value. Such offers may include discounts on fees associated with using the network-based publication system, such as transaction fees, advertising fees, and so on. Or such offers may include discounts on items (e.g., offered by sellers of the items). Thus, users may be encouraged to engage in environmentally-friendly transactions.

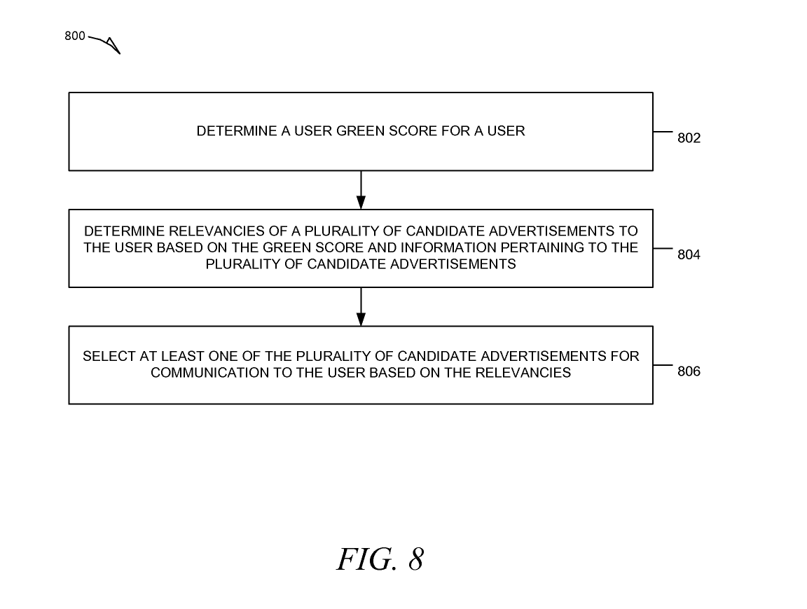

FIG. 8 is a flowchart illustrating example operations of a method 800 of selecting advertising for presentation to a user based on a green score of the user. In various embodiments, the method 800 may be performed by various modules of the green-scoring application(s) 234.

At operation 802, the user-scoring module determines a user green score for the user, as described above.

At operation 804, the advertising module determines relevancies of a plurality of candidate advertisements. The relevancies are based on the user green score and information pertaining to the plurality of candidate advertisements, such as item green scores of the items featured in the advertisements. Thus, advertisements featuring items having higher green scores (e.g., based on item properties, item condition, or item shipping information) may be deemed to be more relevant to users having higher user green scores.

At operation 806, the advertising module selects at least one of the plurality of candidate advertisements for communication to the user based on the relevancies.

FIG. 9 is an example embodiment of a user interface 900 of a profile of a user in which a green score associated with the user is depicted. In this example, a user profile is shown. The user profile is for a user having the username zyenge. As shown, the user has a feedback score of 17 and a green score of 25. In various embodiments, information about how the green score is calculated may be shown in a pop-up user interface element that appears, for example, when the user hovers a mouse cursor over a user name or item name.

FIG. 10 is an example embodiment of a user interface 1000 depicting a green score leaderboard and targeted green score advertising. The leaderboard depicts photos of users having the highest green scores (e.g., as taken from the profiles of the users). In various embodiments, the user viewing the leaderboard is presented with information pertaining to the viewing user's green score (e.g., “Your Green Score is in the Top 30%”). In various embodiments, by selecting a user on the leaderboard, the viewing user may receive information pertaining to the green score of the selected user, such as the selected user's total green score. In various embodiments, the selected user's total green score may be broken down into subscores corresponding to, for example, the selected user's item shipping green score (represented by the truck icon), item condition green score (represented by the three bi-directional arrows arranged in a triangular shape, or item properties green score (not shown).

In various embodiments, the user may also be presented with advertisements selected based on the user's green score. In various embodiments, the higher the user's green score, the more likely advertising presented to the user will feature items having high item green scores.

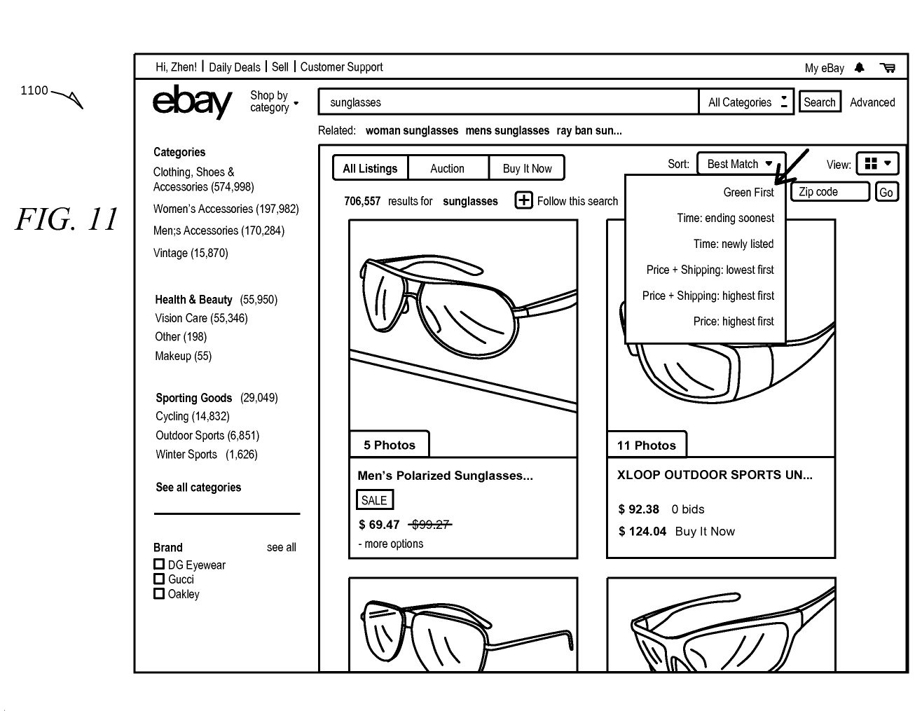

FIG. 11 is an example embodiment of a user interface 1100 depicting an option to filter or rank search results corresponding to items listed on the network-based publication system based on their green scores. For example, in various embodiments, a Sort option presented in conjunction with the search results may include an option to sort by “Green First.” A user may select this option to boost items having higher item green scores in the search results or filter items. Although not shown here, the item green score for an item may be broken down into subscores, such as the item shipping green score, the item properties green score, and the item condition green score. In various embodiments, the subscores are presented to the user based on the user selecting the item green score for the user (e.g., when the user hovers a mouse cursor over the item green score for an item).

FIG. 12 is an example embodiment of a user interface 1200 depicting results of a green filter being applied to search results as well as a visual representation of an item green score. In various embodiments, the item green score may be represented by one or more icons (e.g., green leaf icons) corresponding to the item green score for an item. Thus, as depicted in this this example, in response to the viewing user selecting the “Green First” Sort option, the search result items having the highest item green scores have been brought to the top of the search results.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

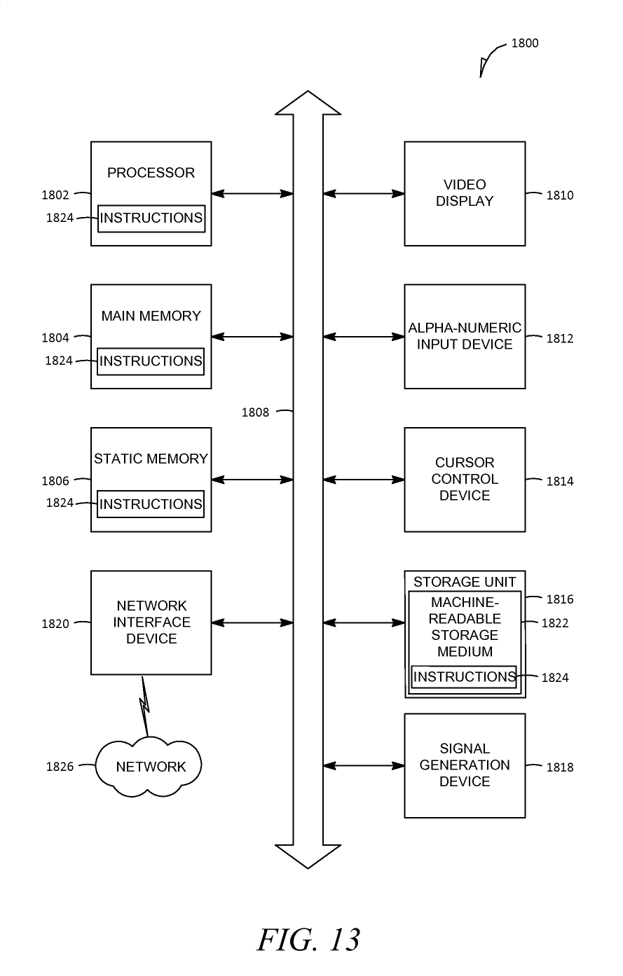

FIG. 13 is a block diagram of machine in the example form of a computer system 1800 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1800 includes a processor 1802 (e.g., a central processing unit (CPU), a graphics processing unit (GPU) or both), a main memory 1804 and a static memory 1806, which communicate with each other via a bus 1808. The computer system 1800 may further include a video display unit 1810 (e.g., a liquid crystal display (LCD) or a cathode ray tube (CRT)). The computer system 1800 also includes an alphanumeric input device 1812 (e.g., a keyboard), a user interface (UI) navigation (or cursor control) device 1814 (e.g., a mouse), a storage unit 1816, a signal generation device 1818 (e.g., a speaker) and a network interface device 1820.

The storage unit 1816 includes a machine-readable medium 1822 on which is stored one or more sets of data structures and instructions 1824 (e.g., software) embodying or utilized by any one or more of the methodologies or functions described herein. The instructions 1824 may also reside, completely or at least partially, within the main memory 1804 and/or within the processor 1802 during execution thereof by the computer system 1800, the main memory 1804 and the processor 1802 also constituting machine-readable media. The instructions 1824 may also reside, completely or at least partially, within the static memory 1806.

While the machine-readable medium 1822 is shown in an example embodiment to be a single medium, the term “machine-readable medium” may include a single medium or multiple media (e.g., a centralized or distributed database, and/or associated caches and servers) that store the one or more instructions 1824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

Accordingly, a “tangible machine-readable medium” may refer to a single storage apparatus or device, as well as “cloud-based” storage systems or storage networks that include multiple storage apparatus or devices. Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 1824 may further be transmitted or received over a communications network 1826 using a transmission medium. The instructions 1824 may be transmitted using the network interface device 1820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible media to facilitate communication of such software. The network 1826 may be one of the networks 104.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
detecting that a user of a network-based publication system has engaged in a transaction;
calculating a transaction green score for the transaction, the transaction green score reflecting an impact on the environment of the engagement by the user in the transaction;
calculating a user green score for the user, the calculating of the user green score including combining the transaction green score with previous transaction green scores calculated for previous engagements by the user in previous transactions; and
communicating the user green score for presentation in a user interface.

2. The method of claim 1, further comprising determining an item condition green score for the transaction based on information pertaining to a condition of the item

3. The method of claim 2, wherein the information includes a specification of whether the item is a new item, a refurbished item, or a used item and wherein the determining of the item condition score results in a higher score for a refurbished item than a new item and a higher score for a used item than a refurbished item.

4. The method of 1, further comprising determining an item shipping green score for the transaction based on information pertaining to shipping of the item.

5. The method of claim 4, wherein the information includes a specification of a distance that the item is to be shipped and wherein the determining of the item shipping green score reflects the distance.

6. The method of claim 1, further comprising determining an item properties green score for the item based on information pertaining to properties of the item.

7. The method of claim 6, wherein the information pertaining to the properties of the item specifies whether the item includes recyclable packaging and wherein the determining of the item properties green score reflects whether the item includes recyclable packaging.

8. A system comprising:
one or more modules implemented by one or more processors, the one or more modules configured to:
detecting that a user of a network-based publication system has engaged in a transaction;
calculating a transaction green score for the transaction, the transaction green score reflecting an impact on the environment of the engagement by the user in the transaction;
calculating a user green score for the user, the calculating of the user green score including combining the transaction green score with previous transaction green scores calculated for previous engagements by the user in previous transactions; and
communicating the user green score for presentation in a user interface.

9. The method of claim 8, further comprising determining an item condition green score for the transaction based on information pertaining to a condition of the item

10. The method of claim 9, wherein the information includes a specification of whether the item is a new item, a refurbished item, or a used item and wherein the determining of the item condition score results in a higher score for a refurbished item than a new item and a higher score for a used item than a refurbished item.

11. The method of 8, further comprising determining an item shipping green score for the transaction based on information pertaining to shipping of the item.

12. The method of claim 11, wherein the information includes a specification of a distance that the item is to be shipped and wherein the determining of the item shipping green score reflects the distance.

13. The method of claim 8, further comprising determining an item properties green score for the item based on information pertaining to properties of the item.

14. The method of claim 13, wherein the information pertaining to the properties of the item specifies whether the item includes recyclable packaging and wherein the determining of the item properties green score reflects whether the item includes recyclable packaging.

15. A non-transitory machine readable medium comprising a set of instructions that, when executed by a processor, causes the processor to perform operations, the operations comprising:
detecting that a user of a network-based publication system has engaged in a transaction;
calculating a transaction green score for the transaction, the transaction green score reflecting an impact on the environment of the engagement by the user in the transaction;
calculating a user green score for the user, the calculating of the user green score including combining the transaction green score with previous transaction green scores calculated for previous engagements by the user in previous transactions; and
communicating the user green score for presentation in a user interface.

16. The non-transitory machine readable medium of claim 1, the operations further comprising determining an item condition green score for the transaction based on information pertaining to a condition of the item

17. The non-transitory machine readable medium of claim 2, wherein the information includes a specification of whether the item is a new item, a refurbished item, or a used item and wherein the determining of the item condition score results in a higher score for a refurbished item than a new item and a higher score for a used item than a refurbished item.

18. The non-transitory machine readable medium of 1, the operations further comprising determining an item shipping green score for the transaction based on information pertaining to shipping of the item.

19. The non-transitory machine readable medium of claim 4, wherein the information includes a specification of a distance that the item is to be shipped and wherein the determining of the item shipping green score reflects the distance.

20. The non-transitory machine readable medium of claim 1, the operations further comprising determining an item properties green score for the item based on information pertaining to properties of the item.
